(19) United States
(12) Patent Application Publication
(10) Pub. No.: US 2026/0269947 A1
(43) Pub. Date: Sep. 10, 2026

(54) Optical Transmitter

(71) Applicant: NTT, Inc., Tokyo (JP)

(72) Inventors: Hiroshi Yamazaki, Musashino-shi, Tokyo (JP); Masanori Nakamura, Musashino-shi, Tokyo (JP); Toshikazu Hashimoto, Musashino-shi, Tokyo (JP); Yutaka Miyamoto, Musashino-shi, Tokyo (JP)

(21) Appl. No.: 19/155,191

(22) PCT Filed: Feb. 15, 2023
(86) PCT No.: PCT/JP2023/005260

§ 371 Date: Aug. 8, 2025

(51) Int. Cl. H04B 10/516

(52) U.S. Cl. CPC H04B 10/516

(57) ABSTRACT

An optical transmitter according to one embodiment includes a modulator including two data modulators that data-modulation each of two optical pulse trains branched from an optical CSRZ pulse train with an electric field waveform frequency of B/2, an optical coupling unit that couples output optical signals from the two data modulators, and an optical delay unit that provides a delay of time τ to the optical pulse train that passes through one of the two data modulators, and a digital signal processor including a sub-signal generator that alternately distributes the symbol train of the optical signal to be transmitted and outputs two sub-signals u₁ and u₂, a first sample shift unit that performs a sample shift on u₂ and outputs u₂′, a 2×2 calculation unit that obtains v₁ and v₂′ from u₁ and u₂′, and a second sample shift unit that performs a sample shift on v₂′ to obtain v_{2.}

### TECHNICAL FIELD

This disclosure relates to an optical transmitter for optical fiber communication.

### BACKGROUND ART

Time-Division Multiplexing (TDM) is one of the means for realizing high-speed communication in an optical fiber communication system. In particular, the CSRZ-TDM method using CSRZ (Carrier-suppressed-return-to-zero) pulses is known as a method for outputting a signal with a symbol rate twice that of a drive signal while suppressing redundant spread of the spectrum (patent literature (PTL) 1 and non patent literature (NPL) 1).

FIG. 1(a) shows an optical modulator for generating a CSRZ-TDM signal in the first reference example of PTL 1. The optical modulator 1000 shown in FIG. 1(a) includes an input optical port 1001, a pulse generator 1111, an optical branch 1231, a first data modulator 1221, a second data modulator 1222, an optical delay unit 1241, an optical multiplexer 1232, and an output optical port 1002. The optical paths on which the first data modulator 1221 and the second data modulator 1222 are arranged are referred to as arm 1 and arm 2, respectively.

The pulse generator 1111 is a push-pull driven Mach-Zehnder modulation circuit biased to a null point and driven by clocks with a frequency of B/2 output from a clock source 1151.

The optical delay unit 1241 provides a delay such that the CSRZ pulse train passing through arm 2 is delayed by T with respect to the CSRZ pulse train passing through arm 1. Note that in this disclosure, when the term “delay” is used simply, it refers to a group delay, not a phase delay. Here, the optical delay unit 1241 is designed so that τ=1/(2B).

The waveform of the output optical electric field E of the pulse generator 1111 (envelope excluding the carrier component) can be expressed as a sine wave with a frequency of B/2 if harmonic components are ignored for simplicity. The peak interval seen in the intensity waveform, that is, the pulse interval, is 1/B, and the positive and negative optical phases are inverted between adjacent pulses. The pulse train input to the second data modulator 1222 is delayed by τ=1/(2B) (that is, ¼ period) from the pulse train input to the first data modulator 1221. Thus, if the symbol timing in the first data modulator 1221 is aligned with the ∇ position in FIG. 1(b) and the symbol timing in the second data modulator 1222 is aligned with the Δ position in FIG. 1(c), no interference occurs in the symbol timing even after the outputs of the data modulators 1221 and 1222 are combined in the optical multiplexer 1232, and a CSRZ-TDM signal with a symbol rate of 2B is obtained. Note that FIG. 1(b) and 1(c) show the electric field waveform excluding the optical carrier component and the data modulation component.

Various optical modulation circuits, such as an optical intensity modulation circuit, an optical IQ modulation circuit, and a polarization multiplexed optical IQ modulation circuit, can be used as the data modulators 1221 and 1222. Although the optical modulator 1000 may be integrally formed on a single optical waveguide substrate, if it is considered as being divided into an optical CSRZ pulse generator 1100 consisting of the pulse generator 1111 and the clock source 1151 and an optical modulator 1200 consisting of the other parts, the optical circuit part of the optical CSRZ pulse generator 1100 and the optical modulator 1200 may be formed on separate optical waveguide substrates and the two may be connected by an optical fiber to obtain the same function.

As an optical modulator for CSRZ-TDM, a configuration such as the optical modulator 2000 shown in FIG. 2(a) is also possible. The input optical port 2001, pulse generator 2111, optical branch 2231, first data modulator 2221, second data modulator 2222, optical delay unit 2241, optical multiplexer 2232, and output optical port 2002 constituting the optical modulator 2000 shown in FIG. 2(a) correspond to the input optical port 1001, pulse generator 1111, optical branch 1231, first data modulator 1221, second data modulator 1222, optical delay unit 1241, optical multiplexer 1232, and output optical port 1002 constituting the optical modulator 1000 shown in FIG. 1(a), respectively.

The only difference between the optical modulator 2000 shown in FIG. 2(a) and the optical modulator 1000 shown in FIG. 1(a) is that the optical delay unit 2241 is arranged downstream of the data modulator 2222 rather than upstream. In this case, if the symbol timing during modulation in the data modulators 2221 and 2222 as shown in FIGS. 2(b) and 2(c) is the same as the symbol timing shown in FIGS. 1(b) and 1(c), it is obvious that a signal equivalent to that of the optical modulator 1000 shown in FIG. 1 can be obtained. In other words, since the CSRZ pulse train passing through arm 2 is given a delay of τ=1/(2B) by the optical delay unit 2241 after data modulation, no interference occurs in the symbol timing even after multiplexing in the optical multiplexer 2232, and a CSRZ-TDM signal is obtained.

Compared to the optical modulator 1000 shown in FIG. 1, the optical modulator 2000 shown in FIG. 2 has the advantage in terms of implementation that the high-frequency electrical wiring from the output source of the drive signal to the optical modulator 2000 can be made equal in length. As with the optical modulator 1000, the optical modulator 2000 can obtain the same functionality whether the optical circuit part of the optical CSRZ pulse generator 2100 and the optical modulator 2200 are integrally formed on a single optical waveguide substrate, or formed on separate optical waveguide substrates and connected by an optical fiber.

To configure an optical transmitter that outputs a CSRZ-TDM signal using the optical modulator shown in FIG. 1 and FIG. 2, the signal source and the drive system may be configured so that the symbol sequence of the signal to be finally output is alternately distributed to the first and second data modulators.

When the optical modulator 1000 shown in FIG. 1 uses polarization multiplexing IQ modulators as the data modulators 1221 and 1222, the layout shown in FIG. 3 can be used. The optical modulator 3200 shown in FIG. 3 includes an optical branch 3231, an optical delay unit 3241, a first polarization multiplexing IQ modulator 3221, a second polarization multiplexing IQ modulator 3222, an X-polarization side optical multiplexer 3232-X, and a Y-polarization side optical multiplexer 3232-Y.

The first polarization multiplexing IQ modulator 3221 includes an optical branch 3261, IQ modulators 3221-X and 3221-Y, a 90-degree polarization rotation unit 3270, and a polarization coupling unit 3280. The second polarization multiplexing IQ modulator 3222 includes an optical branch 3262, IQ modulators 3222-X and 3222-Y, a 90-degree polarization rotation unit 3270, and a polarization coupling unit 3280. That is, the 90-degree polarization rotation unit 3270 and the polarization coupling unit 3280 are shared by the first polarization multiplexing IQ modulator 3221 and the second polarization multiplexing IQ modulator 3222. This is because the 90-degree polarization rotation unit 3270 and the polarization coupling unit 3280 are generally larger than other circuit elements, and are often technically difficult to manufacture. Instead, the function equivalent to the optical multiplexer 1232 in FIG. 1 is decomposed into the X-polarization side optical multiplexer 3232-X and the Y-polarization side optical multiplexer 3232-Y. Note that the IQ modulators 3221-X, 3221-Y, 3222-X, and 3222-Y are each a typical nested Mach-Zehnder-type IQ modulator. Also, in FIG. 3, the positions of the IQ modulators 3221-Y and 3222-X may be interchanged, and the intersection of the waveguides may be located on the input side instead of the output side of the IQ modulator.

In addition, in the optical modulator 2000 shown in FIG. 2, when polarization multiplexed IQ modulators are used as the data modulator 2221 and the data modulator 2222, a layout such as that shown in FIG. 4 may be used. The optical modulator 4200 shown in FIG. 4 includes an optical branch 4231, an X-polarization side optical delay unit 4241-X, a Y-polarization side optical delay unit 4241-Y, a first polarization multiplexing IQ modulator 4221, a second polarization multiplexing IQ modulator 4222, an X-polarization side optical multiplexer 4232-X, and a Y-polarization side optical multiplexer 4232-Y.

The first polarization multiplexing IQ modulator 4221 includes an optical branch 4261, an X-polarization side IQ modulator 4221-X, a Y-polarization side IQ modulator 4221-Y, a 90-degree polarization rotation unit 4270, and a polarization coupling unit 4280. The second polarization multiplexing IQ modulator 4222 includes an optical branch 4262, an X-polarization side IQ modulator 4222-X, a Y-polarization side IQ modulator 4222-Y, a 90-degree polarization rotation unit 4270, and a polarization coupling unit 4280. In other words, the 90-degree polarization rotation unit 4270 and the polarization coupling unit 4280 are shared by the first polarization multiplexing IQ modulator 4221 and the second polarization multiplexing IQ modulator 4222. The reason is the same as in the case of the optical modulator 3200 shown in FIG. 3. Instead, the function corresponding to the optical multiplexer 2232 in FIG. 2 is decomposed into the X-polarization side optical multiplexer 4232-X and the Y-polarization side optical multiplexer 4232-Y, and the function corresponding to the optical delay unit 2241 in FIG. 2 is decomposed into the X-polarization side optical delay unit 4241-X and the Y-polarization side optical delay unit 4241-Y. Note that a typical nested Mach-Zehnder-type IQ modulator is used as the X-polarization side IQ modulators 4221-X and 4222-X and the Y-polarization side IQ modulators 4221-Y and 4222-Y. Furthermore, the positions of the Y-polarization side IQ modulator 4221-Y and the X-polarization side IQ modulator 4222-X in FIG. 4 may be interchanged, and the intersection of the waveguides may be located on the input side instead of the output side of the IQ modulator.

FIG. 5 shows the configuration of a conventional optical transmitter 5000 having a self-evident configuration as an optical transmitter that outputs a CSRZ-TDM signal. The optical transmitter 5000 includes a digital signal processor 5100, a transmitting laser 5200, an optical CSRZ pulse generator 5300, an optical modulator 5400, delay adjustment units 5511 and 5512, and drivers 5521 and 5522.

The optical CSRZ pulse generator 5300 corresponds to the clock source 1151 and the pulse generator 1111 of the optical modulator 1000 shown in FIG. 1, or the clock source 2151 and the pulse generator 2111 of the optical modulator 2000 shown in FIG. 2. The optical modulator 5400 corresponds to the portion from the optical branch 1231 to the optical multiplexer 1232 of the optical modulator 1000 shown in FIG. 1, or the portion from the optical branch 2231 to the optical multiplexer 2232 of the optical modulator 2000 shown in FIG. 2. As the data modulators 1221 and 1222 of FIG. 1 or the data modulators 2221 and 2222 of FIG. 2, a polarization multiplexed optical IQ modulator laid out like the optical modulator 3200 shown in FIG. 3 and the optical modulator 4200 shown in FIG. 4 is used.

The digital signal processor 5100 includes an encoding and mapping unit 5110, a sub-signal generator 5120, and digital-to-analog converter (DAC) arrays 5161 and 5162 that operate at a sampling rate fₛ:fₛ≥B. The configuration of the digital signal processor 5100 is equivalent to that of a digital signal processor in a general digital coherent optical transmitter, except that the transmission symbol sequence is distributed to two subchannels by the sub-signal generator 5120.

The encoding and mapping unit 5110 performs FEC (forward error correction) encoding on the transmission bit sequence, and then maps the encoded bit sequence to a complex symbol sequence of two orthogonal polarizations of X and Y. A known training symbol may be inserted into the symbol sequence as necessary.

The sub-signal generator 5120 alternately distributes the complex symbol sequence of the symbol rate 2B to be transmitted for each polarization channel, converts the sampling rate from B to fₛ, and generates two systems of sub-signals by performing pulse shaping for band limiting and pre-equalization using a filter with the inverse characteristics of the device response (when fₛ=B, pulse shaping and pre-equalization may not be performed).

The DAC arrays 5161 and 5162 output four-lane analog signals corresponding to the I and Q components of each polarization channel. The output sub-signals are amplified by the drivers 5521 and 5522 (four lanes each) and drive the data modulator of the optical modulator 5400. The length of the wiring from the DAC arrays 5161 and 5162 to the optical modulator 5400 is adjusted so that the symbol timing matches the timing of the peak of the intensity waveform of the CSRZ pulse train, but the delay adjustment units 5511 and 5512 may be provided in the wiring to absorb manufacturing errors and the like. By using such an optical transmitter 5000, a CSRZ-TDM output signal with a symbol rate of 2B can be obtained.

### CITATION LIST

### Patent Literature

[PTL 1] Japanese Patent No. 6385848

### Non Patent Literature

[NPL 1]H. Yamazaki, A. Sano, M. Nagatani, and Y. Miyamoto, “Single-carrier 1-Tb/s PDM-16QAM transmission using high-speed InP MUX-DACs and an integrated OTDM modulator,” Opt. Express, vol. 23, no. 10, pp. 12866-12873, May. 2015.

### SUMMARY OF INVENTION

As in the optical modulator 1000 shown in FIG. 1 and the optical modulator 2000 shown in FIG. 2, a configuration in which the timing of the CSRZ pulse is shifted by ¼ period between subchannels using an optical delay unit is the simplest optical modulator for generating a CSRZ-TDM signal. However, since it is generally difficult to make the delay τ provided by the optical delay unit variable, if τ deviates from the ideal value of 1/(2B) due to a change in the symbol rate or a manufacturing error, such a delay error cannot be compensated for by adjustment in the optical domain. For this reason, it is desirable to be able to compensate for the delay error outside the optical modulator. However, the optical transmitter 5000 shown in FIG. 5 cannot compensate for the above-mentioned delay error. At first glance, it seems that the delay error can be compensated for using the delay adjustment units 5511 and 5512, but in reality, only the symbol timing of the drive data signal can be adjusted using them, and the relative timing between the arms of the CSRZ pulse train cannot be adjusted. Similarly, even if a digital delay adjustment unit is provided in each path downstream of the sub-signal generator 5120 in the digital domain, the delay error cannot be compensated for. Therefore, the delay error directly leads to degradation of signal quality, and when changing the symbol rate, a separate optical modulator with a different optical delay unit design must be prepared.

In response to this, the first embodiment of PTL 1 and NPL 1 disclose an optical modulator that can flexibly respond to changes in symbol rate and the like by eliminating the optical delay unit and instead using two Mach-Zehnder modulation circuits for generating CSRZ pulses and adjusting the delay in the analog electrical domain. However, such an optical modulator requires two pulse generators and two clock signals to drive them, which complicates the optical circuit and driving system.

In addition, in both of the above cases, there is a problem that there is no means to compensate for the influence of spurious components (unwanted frequency components) caused by imperfections in the structure of the pulse generator.

This disclosure has been made in consideration of such problems, and an object thereof is to provide a digital signal processing means for compensating for the influence of delay errors and spurious components in the digital domain on the transmitting side in a CSRZ-Optical Time-Division Multiplexing (OTDM) transmitter.

To achieve such a purpose, one embodiment of this disclosure provides an optical transmitter including a digital signal processor, an optical CSRZ pulse generator, and an optical modulator, wherein the optical CSRZ pulse generator is configured to output an optical CSRZ pulse train with an electric field waveform frequency of B/2, the optical modulator includes: an optical branch that branches an input optical CSRZ pulse train into two; two data modulators that data-modulate each of the two branched CSRZ pulse trains; an optical coupling unit that couples the output optical signals from the two data modulators; and an optical delay unit that provides a delay such that the optical CSRZ pulse train passing through one of the two data modulators is delayed by a time T with respect to the optical CSRZ pulse train passing through the other data modulator, and the digital signal processor includes: a sub-signal generator that alternately distributes a symbol sequence of an optical signal to be finally transmitted from the optical modulator for each symbol and outputs two sub-signals u₁(k) and u₂(k):k=0, 1, 2, and so on; a first sample shift unit that performs a sample shift on u₂(k) equivalent to a delay of 1/(2B) and outputs u₂′(k); a 2×2 calculation unit that obtains v₁(k) and v₂′(k) for u₁(k) and u₂′(k) by Formula (1) using Δτ=Σ−1/(2B) and to as parameters; and a second sample shift unit that performs a sample shift on v₂′(k) according to B to obtain v₂(k).

Another embodiment of this disclosure provides an optical transmitter including a digital signal processor, an optical CSRZ pulse generator, and an optical modulator, wherein the optical CSRZ pulse generator is configured to output an optical CSRZ pulse train with an electric field waveform frequency of B/2, the optical modulator includes: an optical branch that branches an input optical CSRZ pulse train into two; two data modulators that data-modulate each of the two branched CSRZ pulse trains; an optical coupling unit that couples the output optical signals from the two data modulators; and an optical delay unit that provides a delay such that the optical CSRZ pulse train passing through one of the two data modulators is delayed by a time τ with respect to the optical CSRZ pulse train passing through the other data modulator, and the digital signal processor includes, for each of X and Y polarization components: a target signal generator that virtually generates a target signal having spectral components within approximately a frequency of ±B; a spectrum splitter that virtually splits the spectrum of the target signal into four adjacent parts spaced approximately by B/2, and generates four digital split signals which correspond to signals virtually frequency-shifted to a baseband; a folding unit that obtains four folded digital split signals by inverting each of the four digital split signals on a frequency axis around a frequency of B/4 and taking complex conjugate; and an 8×4 filter unit that receives an input of the four digital split signals and the four folded digital split signals, and outputs four drive signals which correspond to the I and Q components in each of the X and Y polarization channels of each of the two data modulators.

According to one embodiment of this disclosure, a digital signal processing means for compensating for the influence of delay errors and spurious components in the digital domain on the transmitting side in a CSRZ-OTDM transmitter can be provided.

### BRIEF DESCRIPTION OF DRAWINGS

FIG. 1(a) is a diagram showing the configuration of a conventional CSRZ-TDM optical modulator, FIG. 1(b) shows the electric field waveform of an optical CSRZ pulse train that reaches the output optical port 1002 via arm 1, and FIG. 1(c) shows the electric field waveform of an optical CSRZ pulse train that reaches the output optical port 1002 via arm 2.

FIG. 2(a) is a diagram showing the configuration of a conventional CSRZ-TDM optical modulator, FIG. 2(b) shows the electric field waveform of an optical CSRZ pulse train that reaches the output optical port 2002 via arm 1, and FIG. 2(c) shows the electric field waveform of an optical CSRZ pulse train that reaches the output optical port 2002 via arm 2.

FIG. 3 is a diagram showing the circuit layout of an optical modulator.

FIG. 4 is a diagram showing the circuit layout of an optical modulator.

FIG. 5 is a diagram showing the configuration of a conventional CSRZ-TDM optical modulator.

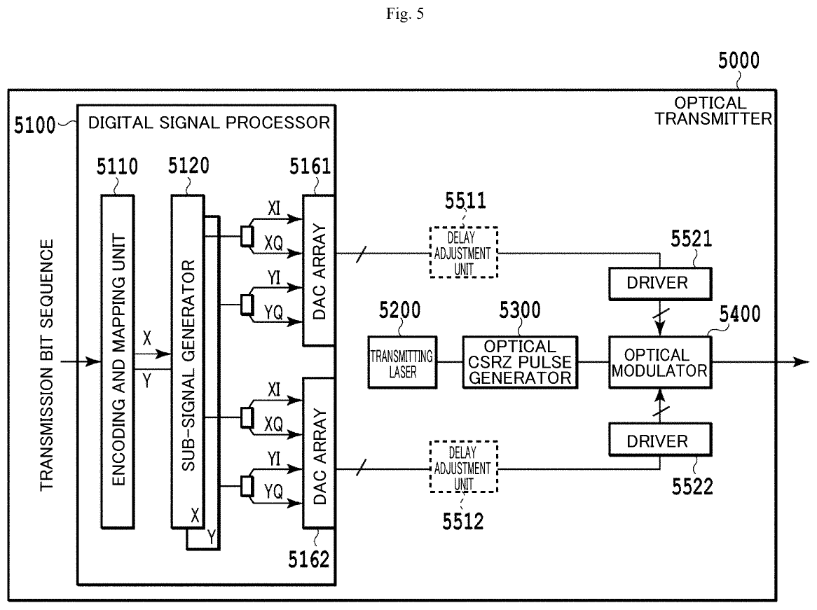

FIG. 6 is a diagram showing the configuration of a CSRZ-TDM optical modulator according to an embodiment of this disclosure.

FIG. 7 is a diagram showing the configuration of a CSRZ-TDM optical modulator according to an embodiment of this disclosure.

FIG. 8 is a diagram explaining the operation of a spectrum splitter, where FIG. 8a(a) shows the spectrum of the optical signal to be generated, and FIG. 8(b) shows the output of a spectrum splitter 7130.

FIG. 9 is a schematic diagram showing the spectrum of an optical CSRZ pulse train, where FIG. 9(a) shows the spectrum of the CSRZ pulse train output via a first data modulator of an optical modulator 7400, and FIG. 9(b) shows the spectrum of the CSRZ pulse train output via a second data modulator of the optical modulator 7400.

FIG. 10 is a diagram showing the correspondence between the spectrum of the drive signal and the symbol, showing the drive signal of the XI component of the first data modulator of the optical modulator 7400.

FIG. 11 is a decomposition diagram of the spectrum of the output optical signal of the optical modulator 7400, where FIG. 11(a) shows the spectrum of the component modulated an optical CSRZ pulse train by the XI component of the first data modulator, FIG. 11(b) shows the spectrum of the component modulated an optical CSRZ pulse train by the XQ component of the first data modulator, FIG. 11(c) shows the spectrum of the component modulated an optical CSRZ pulse train by the XI component of the second data modulator, and FIG. 11(d) shows the spectrum of the component modulated an optical CSRZ pulse train by the XQ component of the second data modulator.

### DESCRIPTION OF EMBODIMENTS

Embodiments of this disclosure will now be described below in detail with reference to the drawings. Note that the following description is an example, and it is possible to make an embodiment in which some of the configuration is changed without departing from the gist of this disclosure.

### First Embodiment

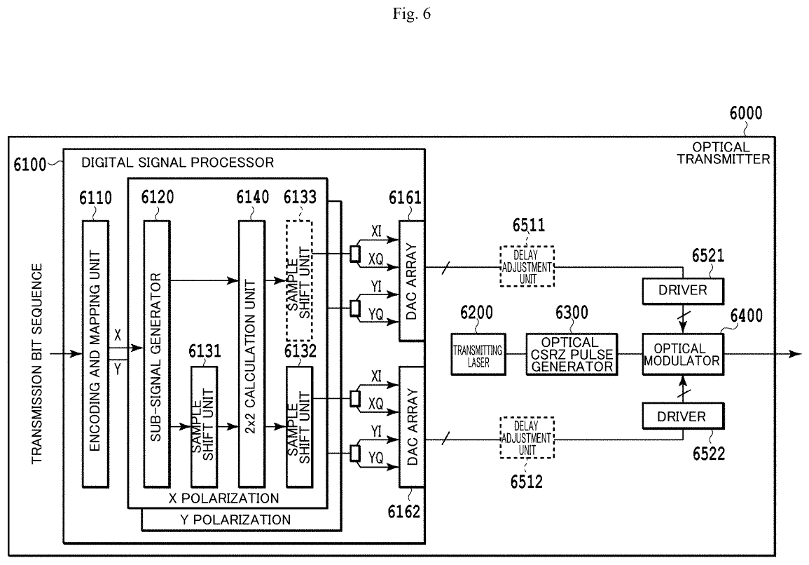

FIG. 6 shows the configuration of an optical transmitter 6000, which is a first embodiment of this disclosure. The optical transmitter 6000 includes a digital signal processor 6100, a transmission laser 6200, an optical CSRZ pulse generator 6300, an optical modulator 6400, delay adjustment units 6511 and 6512, and drivers 6521 and 6522.

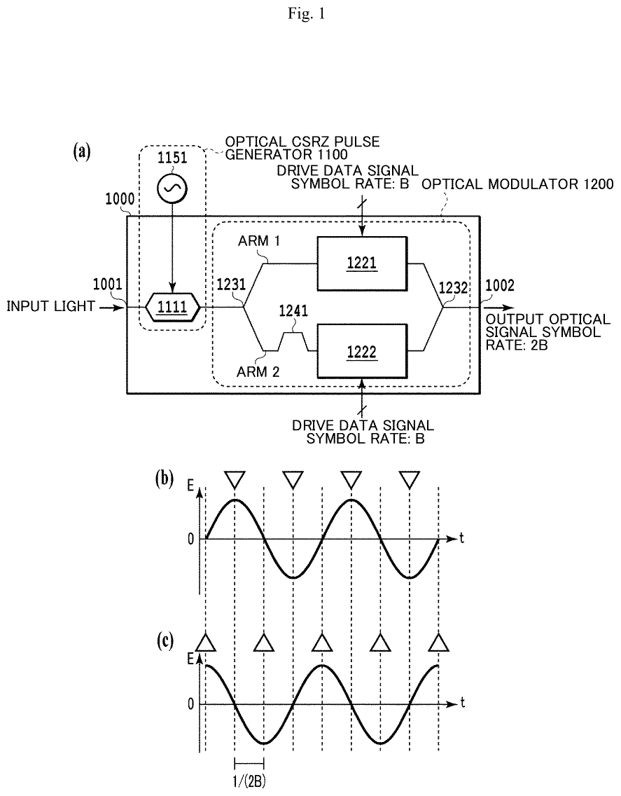

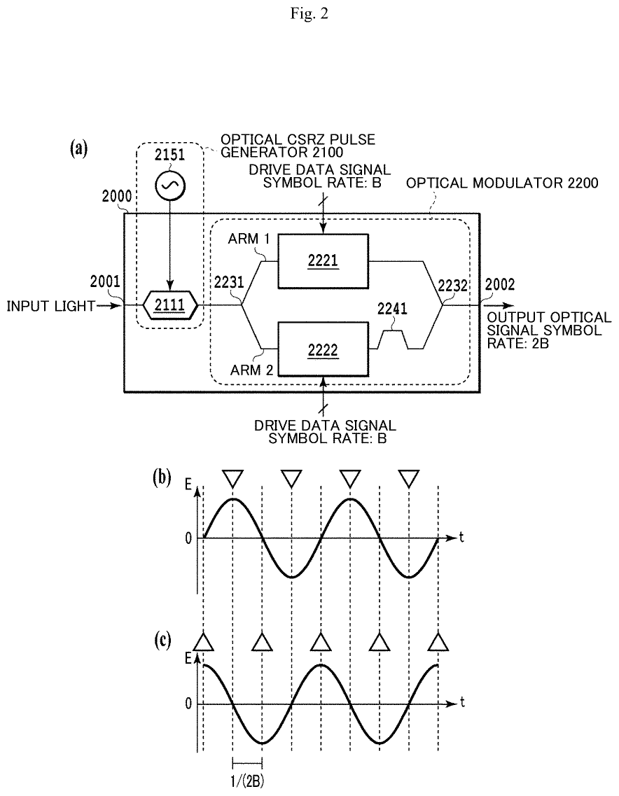

The optical CSRZ pulse generator 6300 corresponds to the clock source 1151 with a frequency of B/2 and the pulse generator 1111 in the optical modulator 1000 shown in FIG. 1, or the clock source 2151 with a frequency of B/2 and the pulse generator 2111 in the optical modulator 2000 shown in FIG. 2.

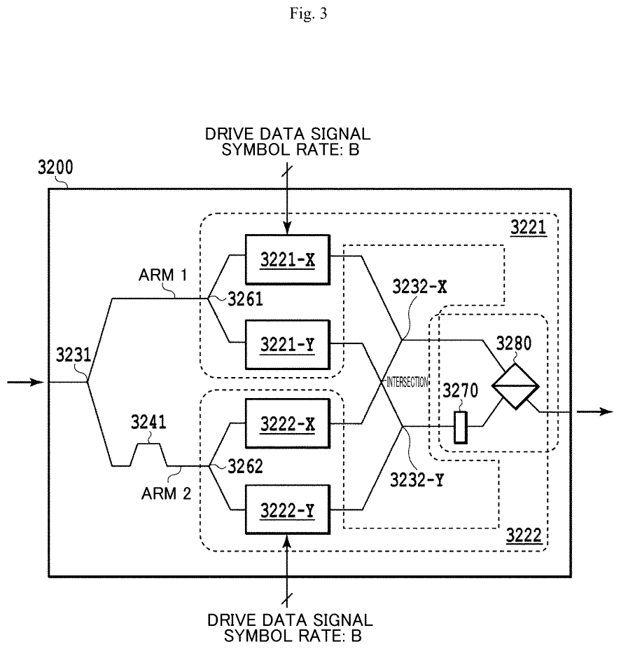

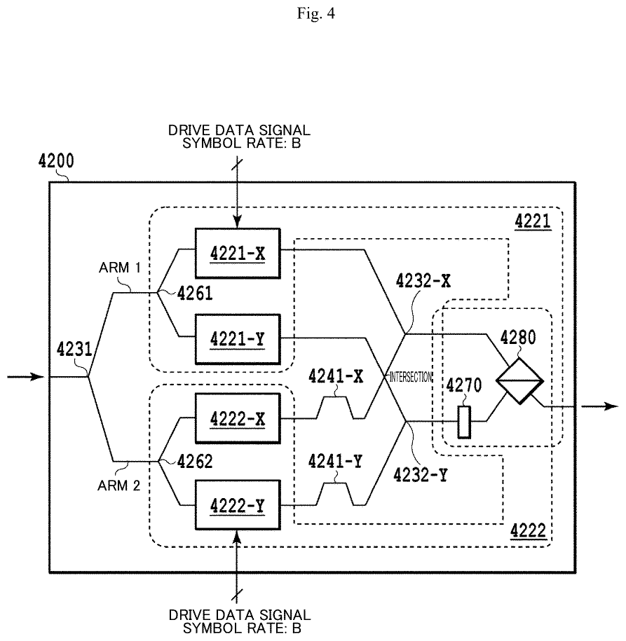

The optical modulator 6400 corresponds to the portion from the optical branch 1231 to the optical multiplexer 1232 in the optical modulator 1000 shown in FIG. 1, or the portion from the optical branch 2231 to the optical multiplexer 2232 in the optical modulator 2000 shown in FIG. 2. The delay provided by the optical delay unit corresponding to the optical delay unit 1241 in FIG. 1 or the optical delay unit 2241 in FIG. 2 is denoted by T. As the data modulators 1221 and 1222 in FIG. 1 or the data modulators 2221 and 2222 in FIG. 2, a polarization multiplexed optical IQ modulator laid out like the optical modulator 3200 in FIG. 3 and the optical modulator 4200 in FIG. 4 is used.

The digital signal processor 6100 includes an encoding and mapping unit 6110, a sub-signal generator 6120, sample shift units 6131, 6132, and 6133, a 2×2 calculation unit 6140, and digital-to-analog converter (DAC) arrays 6161 and 6162 operating at a sampling rate fₛ:fₛ≥B.

The encoding and mapping unit 6110 performs FEC encoding on the transmission bit sequence, and then maps the encoded bit sequence to a complex symbol sequence of two orthogonal polarizations of X and Y. A known training symbol may be inserted into the symbol sequence as necessary. Since the subsequent digital signal processing is basically performed for each polarization channel, the following description focuses only on the X polarization channel for simplicity, but similar processing is performed for the Y polarization channel.

The sub-signal generator 6120 alternately distributes the complex symbol sequence to be transmitted with a symbol rate of 2B for each symbol, converts the sampling rate from B to fₛ, and generates two complex sub-signals by performing pulse shaping for band limiting and pre-equalization using a filter with the inverse characteristics of the device response (when fₛ=B, pulse shaping and pre-equalization may not be performed). Specifically, when the complex symbol sequence to be transmitted is z(n):n=0, 1, 2, and so on for each polarization channel, the sub-signal generator 6120 alternately distributes z(n) to generate a first sub-symbol sequence z₁(m)=(−1)^{m}z(2m):m=0, 1, 2, and so on and a second sub-symbol sequence z₂(m)=(−1)^{m}z(2m+1):m=0, 1, 2, and so on. Furthermore, the sub-signal generator 6120 performs sampling rate conversion, pulse shaping, pre-equalization, and the like on z₁(m) and z₂(m), respectively, and outputs sub-signals u₁(k) and u₂(k):k=0, 1, 2, and so on. However, when fₛ=B, it may simply be u₁(k)=z₁(k) and u₂(k)=z₂(k).

The sample shift unit 6131 performs a sample timing shift on u₂(k) equivalent to a time delay of 1/(2B) and outputs u₂′(k).

The 2×2 calculation unit 6140 outputs v₁′(k) and v₂′(k) by the calculation expressed as Formula (1).

$$( \begin{matrix}{v}_{1}^{′} & ( k ) \\ {v}_{2}^{′} & ( k )\end{matrix} ) = ( \begin{matrix}cos \{ π B ( {t}_{0} + Δτ ) \} & sin \{ π {Bt}_{0} + Δτ ) \} \\ - sin ( π Bt ) & cos ( π {Bt}_{0} )\end{matrix} ) ( \begin{matrix}{u}_{1} ( k ) \\ {u}_{1}^{′} ( k )\end{matrix} ) \qquad ( 1 )$$

However, Δτ=τ−1/(2B), and t₀ is a parameter related to the relative timing difference between the optical CSRZ pulse train and the drive signal, as described below.

The sample shift units 6133 and 6132 shift the sample timing of v₁′(k) and v₂′(k), respectively, and output v₁(k) and v₂(k). The amount of shift here depends on B and the wiring length, as described below.

The DAC arrays 6161 and 6162 output four-lane analog signals corresponding to the I and Q components of each of the two orthogonal polarization channels. The output sub-signals are amplified by the drivers 6521 and 6522 (four lanes each) and drive the data modulator of the optical modulator 6400. The length of the wiring from the DAC arrays 6161 and 6162 to the optical modulator 6400 is adjusted so that the symbol timing matches the timing of the peak of the intensity waveform of the CSRZ pulse train, but the delay adjustment units 6511 and 6512 may be provided in the wiring to absorb manufacturing errors and the like. By using such an optical transmitter 6000, a CSRZ-TDM output signal with a symbol rate of 2B can be obtained.

The principle of delay error compensation by the sample shift units 6131, 6132, 6133 and the 2×2 calculation unit 6140 will be analytically explained below. In the following explanation, only the X-polarized signal is considered for simplicity, but compensation is performed in a similar manner for the Y-polarized signal. When expressing the electric field waveform in a formula, the carrier component of the transmission laser frequency is omitted.

First, the electric field waveform of the CSRZ pulse in this example can be expressed as Formula (2) if higher-order terms are ignored for simplicity. However, to is a parameter corresponding to the time origin of the pulse electric field waveform, and can be adjusted using a phase shifter or the like inside the optical CSRZ pulse generator 6300.

$${x}_{CSRZ} ( t ) = cos \{ π B ( t - {t}_{0} ) \} \qquad ( 2 )$$

The waveform of the complex data signal sent to the first data modulator in the optical modulator 6400 is s₁(t), and the waveform of the complex data signal sent to the second data modulator in the optical modulator 6400 is s₂(t). The electric field waveform of the final optical output signal is xₒᵤₜ(t), the component that passes through the first data modulator is x₁(t), and the component that passes through the second data modulator is x₂(t). If the scale factors representing the modulation efficiency and optical loss are ignored for simplicity, xₒᵤₜ(t), x₁(t), and x₂(t) can be expressed as Formula (3a), Formula (3b), and Formula (3c), respectively.

$${x}_{out} ( t ) = {x}_{1} ( t ) + {x}_{2} ( t ) \qquad ( 3 a )$$

$${x}_{1} ( t ) = {s}_{1} ( t - {t}_{1} ) {x}_{C S R Z} ( t ) = {s}_{1} ( t - {t}_{1} ) cos \{ π B ( t - {t}_{0} ) \} \qquad ( 3 b )$$

$${x}_{2} ( t ) = {s}_{2} ( t - {t}_{2} - τ ) {x}_{CSRZ} ( t - τ ) = {s}_{2} ( t - {t}_{2} - τ ) cos \{ π B ( t - {t}_{0} - τ ) \} \qquad ( 3 c )$$

Here, t₁ and t₂ are the time shifts of the drive signals s₁ and s₂, respectively, and are determined by the wiring design, but can also be adjusted using the delay adjustment units 6511 and 6512.

Ideally, τ=1/(2B), but due to changes in the symbol rate, manufacturing errors, and the like, τ≠1/(2B) may occur. In this case, the deviation in τ, that is, the delay error, cannot be compensated for by simply adjusting t₀, t₁, and t₂. This is because, as is clear from Formulas (3b) and (3c), while the timing difference between s₁ and s₂ between subchannels can be set arbitrarily by adjusting t₁ and t₂, the timing difference between the electric field waveform x_{CSRZ} of the CSRZ pulse between subchannels is determined only by τ. Thus, in a CSRZ-TDM optical transmitter, the delay error provided by the optical delay unit cannot be compensated for by the intuitive method of adjusting the timing of the clock and each sub-signal.

The principle of delay error compensation in this disclosure is based on the idea of compensating for delay errors by performing 2-input, 2-output arithmetic processing in the digital domain, rather than individually adjusting the delays of the sub-signals once distributed by the sub-signal generator. To proceed with the explanation, first consider the ideal case with no errors, that is, the output waveform x_{out,ideal}(t) when τ=1/(2B). In this case, the 2×2 calculation unit 6140 simply sets v₁(k)=u₁(k) and v₂(k)=u₂(k), and t₀=t₁=t₂=0. If s₁(t) and s₂(t) in the case of τ=1/(2B) and v₁(k)=u₁(k) and v₂(k)=u₂(k) are expressed as S_{1,ideal}(t) and S_{2,ideal}(t), respectively, the output waveform x_{out,ideal}(t) can be expressed as Formula (4).

$${x}_{out , ideal} ( t ) = {s}_{1 , ideal} ( t ) cos ( π Bt ) + {s}_{2 , ideal} ( t - \frac{1}{2 B} ) sin ( π Bt ) \qquad ( 4 )$$

The first term on the right side of Formula (4) is zero when t=2m/2B:m=0, 1, 2, and so on, and the second term is zero when t=(2m+1)/2B:m=0, 1, 2, and so on. If the impulse responses including the analog responses from the DAC arrays 6161 and 6162 to the optical modulator 6400 and the pulse shaping and pre-equalization in the sub-signal generator 6120 are h₁(t) and h₂(t), respectively, then S_{1,ideal}(t) and S_{2,ideal}(t) can be expressed as Formulas (5a) and (5b), respectively.

$${s}_{1 , ideal} ( t ) = {\sum }_{l} {z}_{1} ( l ) {h}_{1} ( t − \frac{l}{B} ) \qquad ( 5 a )$$

$$\begin{matrix} & {s}_{2 , ideal} ( t ) = {\sum }_{l} {z}_{2} ( l ) {h}_{2} ( t − \frac{l}{B} )\end{matrix} \qquad ( 5 b )$$

For the sake of simplicity, let us consider the case where there is no intersymbol interference at the output of the optical modulator 6400, that is, where h₁(t) and h₂(t) each have a value of 1 at t=0 and a value of 0 at t=±m/B:m=1, 2, 3, and so on (where pre-equalization is performed in the sub-signal generator 6120 so that this occurs). The output waveform x_{out,ideal}(t) is provided by Formulas (6a), (6b), and (6c), and it can be confirmed that x_{out,ideal}(t) are indeed signals with symbol values z(n):n=0, 1, 2, and so on and a symbol rate of 2B.

$${x}_{out , ideal} ( \frac{2 m}{2 B} ) = {( - 1 )}^{m} {s}_{1 , ideal} ( \frac{2 m}{2 B} ) = {( - 1 )}^{m} {z}_{1} ( m ) = z ( 2 m ) \qquad ( 6 a )$$

$${x}_{out , ideal} ( \frac{2 m + 1}{2 B} ) = {( - 1 )}^{m} {s}_{2 , ideal} ( \frac{2 m}{2 B} ) = {( - 1 )}^{m} {z}_{2} ( m ) = z ( 2 m + 1 ) \qquad ( 6 b )$$

$$∴ {x}_{out , ideal} ( \frac{n}{2 B} ) = z ( n ) : n = 0 , 1 , 2 , … \qquad ( 6 c )$$

Next, let us consider the general case where there is an error, that is, the case where τ≈1/(2B). The electric field waveform xₒᵤₜ(t) of the final optical output signal in this case can be expressed as Formula (3a). If s₁(t) and s₂(t) can be adjusted so that xₒᵤₜ(t) expressed as Formula (3a) is equal to x_{out,ideal}(t) expressed as Formula (4), the error in the differential group delay can be compensated for. That is, s₁(t) and s₂(t) should be determined so that Formula (6) holds.

$$\begin{matrix}{x}_{out} ( t ) = {s}_{1} ( t - {t}_{1} ) cos \{ π B ( t - {t}_{0} ) \} + {s}_{2} ( t - {t}_{2} - τ ) cos \{ π B ( t - {t}_{0} - τ ) \} \\ = {s}_{1 , ideal} ( t ) cos ( π Bt ) + {s}_{2 , ideal} ( t - \frac{1}{2 B} ) sin ( π Bt )\end{matrix} \qquad ( 6 )$$

If Formula (6) is expanded with τ=1/(2B)+A, Formula (7) is obtained.

$$( 7 )$$

$$\begin{matrix}\begin{matrix}{s}_{1} ( t - {t}_{1} ) cos \{ π B ( t - {t}_{0} ) \} + \\ {s}_{2} ( t - {t}_{2} - τ ) \\ cos \{ π B ( t - {t}_{0} - τ ) \}\end{matrix} = \begin{matrix}{s}_{1} ( t - {t}_{1} ) cos \{ π B ( t - {t}_{0} ) \} + {s}_{2} ( t - {t}_{2} - \\ Δτ - \frac{1}{2 B} ) sin \{ π B ( t - {t}_{0} - Δτ ) \}\end{matrix} \\ = \begin{matrix}[ {s}_{1} ( t - {t}_{1} ) cos ( π {Bt}_{0} ) - {s}_{2} ( t - {t}_{2} - Δτ - \\ \frac{1}{2 B} ) sin \{ π B ( {t}_{0} + Δ τ ) \} ] cos ( π Bt ) + \\ [ {s}_{1} ( t - {t}_{1} ) sin ( π {Bt}_{0} ) + {s}_{2} ( t - {t}_{2} - Δτ - \\ \frac{1}{2 B} ) cos \{ π B ( {t}_{0} ⋆ Δ τ ) \} ] sin ( π Bt )\end{matrix} \\ = {s}_{1 , ideal} ( t ) cos ( π Bt ) + {s}_{2 , ideal} ( t - \frac{1}{2 B} ) sin ( π Bt )\end{matrix}$$

Comparing the coefficients of cos(πBt) and sin(πBt) in Formula (7), it can be seen that Formula (6) holds if Formula (8) holds.

$$( \begin{matrix}{s}_{1 , ideal} ( t ) \\ {s}_{2 , ideal} ( t - \frac{1}{2 B} )\end{matrix} ) = ( \begin{matrix}cos ( π {Bt}_{0} ) & - sin \{ π B ( {t}_{0} + Δτ ) \} \\ sin ( π {Bt}_{0} ) & cos \{ π B ( {t}_{0} + Δτ ) \}\end{matrix} ) ( \begin{matrix}{s}_{1} ( t - {t}_{1} ) \\ {s}_{2} ( t - {t}_{2} - Δ τ - \frac{1}{2 B} )\end{matrix} ) \qquad ( 8 )$$

If the inverse matrix of the 2×2 matrix on the right side of Formula (8) is multiplied from the left to both sides and rearranged, Formula (9) is obtained.

$$( \begin{matrix}{s}_{1} ( t - {t}_{1} ) \\ {s}_{2} ( t - {t}_{2} - Δ τ - \frac{1}{2 B} )\end{matrix} ) = \frac{1}{cos ( π B Δτ )} ( \begin{matrix}cos \{ π B ( {t}_{0} + Δτ ) \} & sin \{ π B ( {t}_{0} + Δτ ) \} \\ - sin ( π {Bt}_{0} ) & cos ( π {Bt}_{0} )\end{matrix} ) ( \begin{matrix}{s}_{1 , ideal} ( t ) \\ {s}_{2 , ideal} ( t - \frac{1}{2 B} )\end{matrix} ) \qquad ( 9 )$$

The sample shift units 6131, 6132, and 6133 and the 2×2 calculation unit 6140 in this disclosure perform an operation equivalent to Formula (9) in the digital domain. To perform this process appropriately, it is desirable that the spectral components of S_{1,ideal}(t) and S_{2,ideal}(t) are sufficiently within ±fₛ/2, which is the Nyquist frequency. This condition is naturally met if the analog bandwidth of the DAC is sufficiently smaller than the Nyquist frequency, but if the analog bandwidth of the DAC is larger than the Nyquist frequency, it is desirable to introduce an anti-aliasing filter in the analog domain on the DAC output side. In the following, it is considered that the proportion of the components of f>fₛ/2 and f<-fₛ/2 among the spectral components of S_{1,ideal}(t) and S_{2,ideal}(t) is sufficiently small, and aliasing can be ignored. Then, if discrete signals obtained by sampling S_{1,ideal}(t) and S_{2,ideal}(t) at a sampling rate of fₛ are used as u₁(k) and u₂(k), respectively, then processing equivalent to Formula (8) can be performed using Formula (1) mentioned above. The shift amounts in the sample shift units 6133 and 6132 correspond to delays of −t₁ and −t₂-Δ_{τ}-1/(2B), respectively, based on Formula (8). If t₁=0 can be achieved by wiring design or adjustment of the delay adjustment unit 6511, the sample shift unit 6133 is not necessary, but the sample shift unit 6132 is necessary to ensure flexibility in response to changes in symbol rate B and cannot be omitted.

In this way, by using the sample shift units 6131, 6132, and 6133 and the 2×2 calculation unit 6140 in the digital signal processor 6100, even if there is a delay error Δt due to a symbol rate change, a manufacturing error, or the like, it is possible to output a final optical output signal that is equivalent to a signal without ΔT.

Note that it is desirable to measure the value of T at the time of shipping inspection of the optical modulator 6400, but it can also be measured using a known test signal after being incorporated into the optical transmitter 6000.

### Second Embodiment

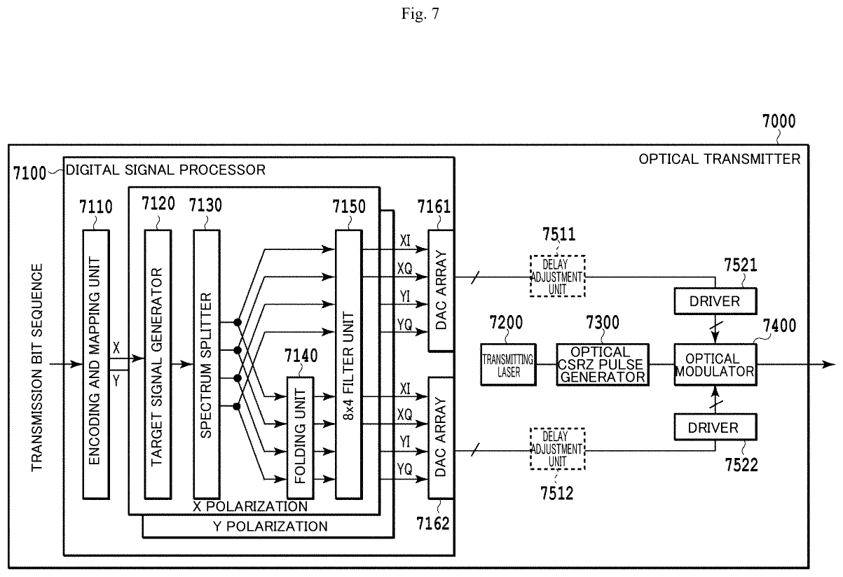

FIG. 7 shows the configuration of an optical transmitter 7000, which is a second embodiment of this disclosure. The optical transmitter 7000 includes a digital signal processor 7100, a transmission laser 7200, an optical CSRZ pulse generator 7300, an optical modulator 7400, delay adjustment units 7511 and 7512, and drivers 7521 and 7522.

The optical CSRZ pulse generator 7300 corresponds to the clock source 1151 with a frequency of B/2 and the pulse generator 1111 in the optical modulator 1000 shown in FIG. 1, or the clock source 2151 with a frequency of B/2 and the pulse generator 2111 in the optical modulator 2000 shown in FIG. 2.

The optical modulator 7400 corresponds to the portion from the optical branch 1231 to the optical multiplexer 1232 in the optical modulator 1000 shown in FIG. 1, or the portion from the optical branch 2231 to the optical multiplexer 2232 in the optical modulator 2000 shown in FIG. 2. The delay provided by the optical delay unit corresponding to the optical delay unit 1241 in FIG. 1 or the optical delay unit 2241 in FIG. 2 is denoted as T. As the data modulators 1221 and 1222 in FIG. 1 or the data modulators 2221 and 2222 in FIG. 2, a polarization multiplexed optical IQ modulator laid out like the optical modulator 3200 in FIG. 3 and the optical modulator 4200 in FIG. 4 is used.

The digital signal processor 7100 includes an encoding and mapping unit 7110, a target signal generator 7120, a spectrum splitter 7130, a folding unit 7140, an 8×4 filter unit 7150, and digital-to-analog converter (DAC) arrays 7161 and 7162 that operate at a sampling rate of fₛ:fₛ≥B.

The encoding and mapping unit 7110 performs FEC encoding on the transmission bit sequence, and then maps the encoded bit sequence to a complex symbol sequence of two orthogonal polarizations of X and Y. A known training symbol may be inserted into the symbol sequence as necessary. In this embodiment, the complex symbol sequence does not necessarily have to be a single-carrier system with one sequence for each polarization channel, but may be a multi-carrier system in which a plurality of symbol sequences are allocated to a plurality of RF subcarriers. The symbol rate can also be any value equal to or less than 2B. Since the subsequent digital signal processing is basically performed for each polarization channel, the following description focuses only on the X polarization channel for simplicity, but similar processing is performed for the Y polarization channel.

The target signal generator 7120 virtually generates a signal waveform to be generated around the optical carrier as the final output of the optical transmitter 7000 according to the input complex symbol sequence. For example, when a single carrier signal is used as the target signal, the desired pulse waveform can be simply convolved with one symbol sequence received from the encoding and mapping unit 7110. When a multicarrier signal is used as the target signal, the desired pulse waveform can be convolved with each of the plurality of symbol sequences received from the encoding and mapping unit 7110 and then added. However, the spectral components of the target signal must be generally concentrated within ±B. Therefore, the symbol rate in the case of a single carrier signal must basically be 2B or less.

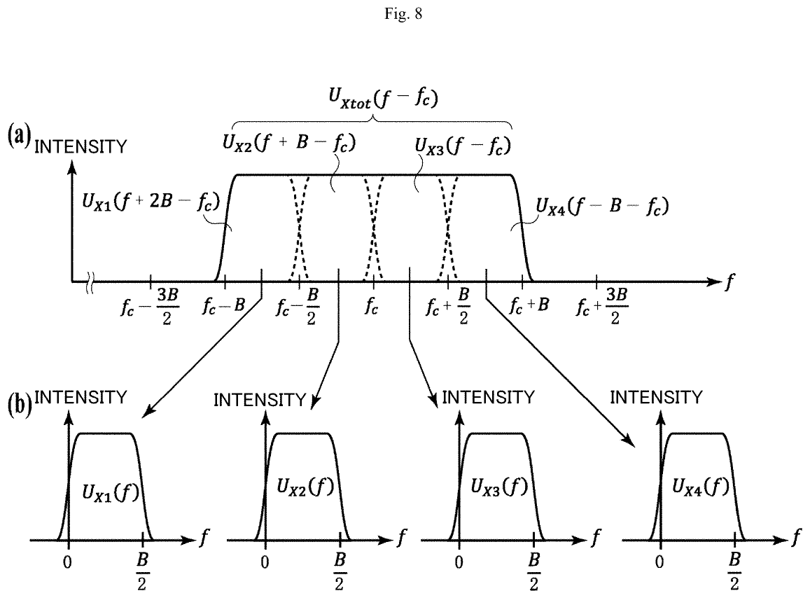

FIG. 8 is a diagram explaining the operation of the spectrum splitter 7130. When the spectrum of the X-polarized component of the target signal sent from the target signal generator 7120 is U_{Xtot}(f) and the optical carrier frequency is f_{c}, the spectrum of the optical signal to be generated can be expressed in complex notation as U_{Xtot}(f-f_{c}) as shown in FIG. 8(a). The spectrum splitter 7130 virtually splits U_{Xtot}(f-f_{c}) around f_{c} into four parts with a width of approximately B/2 each, as shown in FIG. 8(b), and outputs four digital split signals represented by the virtually shifted spectrums U_{X1}(f), U_{X2}(f), U_{X3}(f), and U_{X4}(f) to the baseband. As shown in FIG. 8, U_{Xtot}(f-f_{c})=U_{X1}(f+2B-f_{c})+U_{X2}(f+B-f_{c})+U_{X3}(f-f_{c})+U_{X4}(f-B-f_{c}).

The folding unit 7140 inverts U_{X1}(f), U_{X2}(f), U_{X3}(f), and U_{X4}(f) on the frequency axis around B/4 to take the complex conjugate, and outputs four folded digital split signals. The spectrum of the four folded digital split signals is expressed as follows. Here, the superscript asterisk represents the complex conjugate.

$$\tilde{{U}_{X 1}} ( f ) , \tilde{{U}_{X 2}} ( f ) , \tilde{{U}_{X 3}} ( f ) , \tilde{{U}_{X 4}} ( f )$$

$$\tilde{{U}_{Xl}} ( f ) = {U}_{Xl}^{⋆} ( B / 2 - f ) : l = 1 , 2 , 3 , 4$$

The 8×4 filter unit 7150 receives the four digital split signals and the four folded digital split signals as input, and outputs four signals by 8-input 4-filter processing. The method of determining the filter coefficients of the 8×4 filter unit 7150 will be described later. The four output signals of the 8×4 filter unit 7150 are real signals corresponding to the I and Q components of the first and second sub-signals of the corresponding polarization, respectively. Here, the first sub-signal is a signal that drives the first data modulator of the optical modulator 7400 via the DAC array 7161 and the driver 7521. The second sub-signal is a signal that drives the second data modulator of the optical modulator 7400 via the DAC array 7162 and the driver 7522. The drivers 7521 and 7522 after the DAC arrays 7161 and 7162 are similar to the drivers 6521 and 6522 after the DAC arrays 6161 and 6162 in the first embodiment described above, so their explanation is omitted.

In this embodiment, not only the delay error whose compensation method was described in the first embodiment, but also the influence of spurious components caused by imperfections in the optical CSRZ pulse generator 7400 can be compensated for, and any signal can be generated as long as the spectral components are concentrated within the optical carrier frequency ±B, not limited to a single carrier signal with a symbol rate of 2B. The principle is explained below.

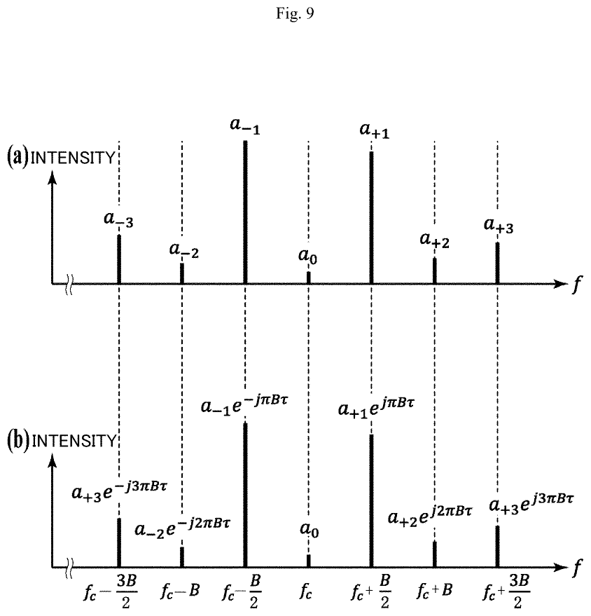

FIG. 9 is a schematic diagram showing the spectrum of an optical CSRZ pulse train when there is an imperfection in the optical CSRZ pulse generator 7400. FIG. 9(a) shows the spectrum of a CSRZ pulse train output via the first data modulator of the modulator 7400, and FIG. 9(b) shows the spectrum of a CSRZ pulse train output via the second data modulator of the modulator 7400. In addition to the main component f_{c}±B/2, spurious components occur at frequencies that are integer multiples of B/2 around f_{c}. For example, when a null-biased push-pull driven Mach-Zehnder modulator is used as the optical CSRZ pulse generator and driven by a clock with a frequency of B/2, components f_{c}±3B/2, f_{c}±5B/2, and so on occur due to the nonlinearity (sine wave response) of the output optical electric field with respect to the drive voltage, and further, components f_{c}, f_{c}±B, f_{c}±2B, and so on occur due to the optical loss between the arms of the Mach-Zehnder modulator, the phase modulation efficiency, or the imbalance of the drive voltage amplitude. As shown in FIG. 9(a), if the complex electric field amplitudes of the components of the spectrum of the optical CSRZ pulse train output via the first data modulator of the optical modulator 7400 are a₀, a_{±1}, a_{±2}, and so on, then the complex electric field amplitudes of the components of the optical CSRZ pulse train output via the second data modulator in the optical modulator 7400 are a₀, a_{±1exp}(±jπcBτ), a_{±2exp}(±2jπBτ), and so on, as shown in FIG. 9(b).

Now, when such an optical CSRZ pulse train including spurious components is input to the optical modulator 7400 and modulated and combined by the sub-signals sent from the DACs 7161 and 7162, in the frequency domain, the spectrum of the drive signal is convolved with the above-mentioned main component as well as each spurious component, and an optical signal having a spectrum in which the respective components overlap in a complex manner is output from the optical modulator 7400.

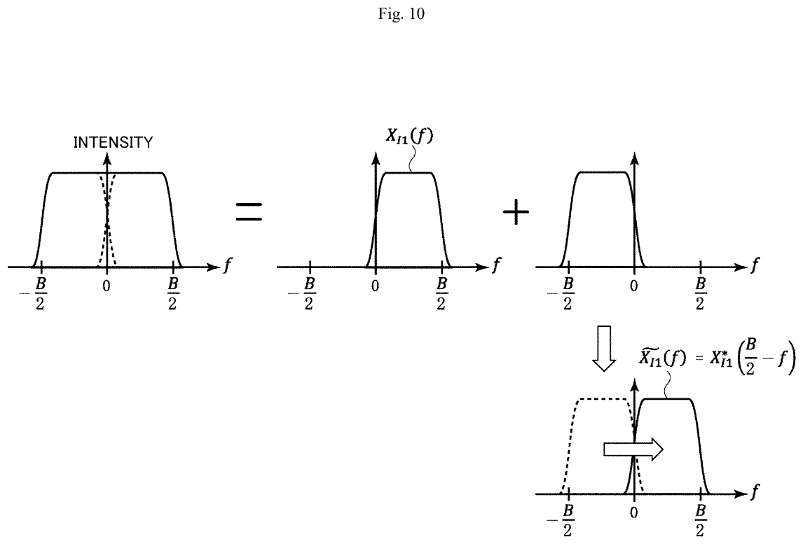

Here, consider splitting each spectrum of the drive signal of the optical modulator 7400 into two, the positive frequency side and the negative frequency side, as shown in FIG. 10. Because it is a real signal, the component obtained by shifting the negative frequency side component to the positive frequency side by +B/2 is equal to the positive frequency side component folded back around B/4 and complex conjugate is taken. For example, if the positive frequency side component of the spectrum of the drive signal of the XI component of the first data modulator of the optical modulator 7400 is X₁₁(f), the component obtained by shifting the negative frequency side component to the positive frequency side by +B/2 can be expressed as follows using the tilde symbol mentioned above.

$$\tilde{{X}_{I 1}} ( f )$$

Similarly, the components obtained by shifting the negative frequency side component to the positive frequency side by +B/2 for X_{Q1}(f), X₁₂(f), and X_{Q2}(f) can be expressed as follows using the tilde symbol mentioned above.

$$\tilde{{X}_{Q 1}} ( f ) , \tilde{{X}_{I 2}} ( f ) , \tilde{{X}_{Q 2}} ( f )$$

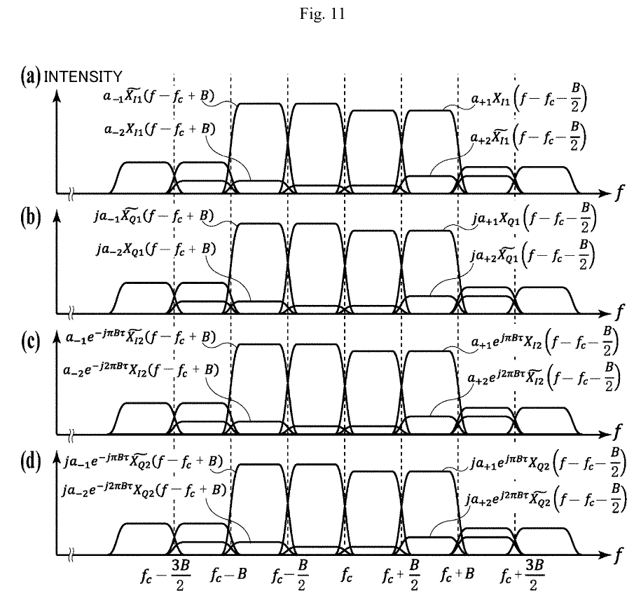

In light of the above, FIG. 11 shows a schematic diagram of the state in which each of the drive signals of the optical modulator 7400 is convolved with the spectrum of the optical CSRZ pulse as shown in FIG. 9. FIG. 11(a) shows the spectrum of the component modulated the optical CSRZ pulse train by the XI component of the first data modulator, FIG. 11(b) shows the spectrum of the component modulated the optical CSRZ pulse train by the XQ component of the first data modulator, FIG. 11(c) shows the spectrum of the component modulated the optical CSRZ pulse train by the XI component of the second data modulator, and FIG. 11(d) shows the spectrum of the component modulated the optical CSRZ pulse train by the XQ component of the second data modulator. In order to avoid complicating the figure, only some of the symbols are shown. The final optical output signal of the optical transmitter 7000 is the result of superimposing all of these. Comparing FIG. 11 and FIG. 8, it can be seen that in order to obtain the target signal Uₜₒₜ(f-f_{c}) as the final optical output signal of the optical transmitter 7000, it is sufficient that the relationships shown in Formulas (10a) and (10b) below hold.

$$( \begin{matrix}{U}_{X 1} ( f ) \\ {U}_{X 2} ( f ) \\ {U}_{X 3} ( f ) \\ {U}_{X 4} ( f )\end{matrix} ) = {A}_{4 \times 3} ( \begin{matrix}{X}_{I 1} ( f ) \\ {X}_{Q 1} ( f ) \\ {X}_{I 2} ( f ) \\ {X}_{Q 2} ( f ) \\ \tilde{{X}_{I 1}} ( f ) \\ \tilde{{X}_{Q 1}} ( f ) \\ \tilde{{X}_{I 2}} ( f ) \\ \tilde{{X}_{Q 2}} ( f )\end{matrix} ) \qquad ( 10 a )$$

$$where$$

$${A}_{4 \times 8} = ( \begin{matrix}{a}_{− 2} & j {a}_{− 2} & {a}_{− 2} {e}^{− j2 π Bx} & j {a}_{− 2} {e}^{− j2 π Bx} & {a}_{− 1} & j {a}_{− 1} & {a}_{− 1} {e}^{− j π Bx} & j {a}_{− 1} {e}^{− j π Bx} \\ {a}_{− 1} & j {a}_{− 1} & {a}_{− 1} {e}^{− j π Bx} & j {a}_{− 1} {e}^{− j πBx} & {a}_{0} & j {a}_{0} & {a}_{0} & j {a}_{0} \\ {a}_{0} & j {a}_{0} & {a}_{0} & j {a}_{0} & {a}_{+ 1} & j {a}_{+ 1} & {a}_{+ 1} {e}^{j πBx} & j {a}_{+ 1} {e}^{j π Bx} \\ {a}_{+ 1} & j {a}_{+ 1} & {a}_{+ 1} {e}^{j π Bx} & j {a}_{+ 1} {e}^{j π Bx} & {a}_{+ 2} & j {a}_{+ 2} & {a}_{+ 2} {e}^{j2 π Bx} & j {a}_{+ 2} {e}^{j2 π Bx}\end{matrix} ) \qquad ( 10 b )$$

The coefficients of the 8×4 filter unit 7150 must be determined so that Formulas (10a) and (10b) are satisfied. Of the four output signals from the 8×4 filter unit 7150, if the positive frequency components of the spectrum of the signal sent to the XI and XQ modulators of the first data modulator of the optical modulator 7400 are Vₓ₁₁(f) and V_{XQ1}(f), respectively, and the positive frequency components of the spectrum of the signal sent to the XI and XQ modulators of the second data modulator of the optical modulator 7400 are V_{X12}(f) and V_{XQ2}(f), respectively, then X₁₁(f), X_{Q1}(f), X₁₂(f), and X_{Q2}(f) are respectively obtained by multiplying V_{X11}(f), V_{XQ1}(f), V_{X12}(f), V_{XQ2}(f) by the frequency response of the path from DACs 7161 and 7162 to the optical modulator 7400, and can be expressed as in Formula (11).

$$( \begin{matrix}{X}_{I 1} ( f ) \\ {X}_{Q 1} ( f ) \\ {X}_{I 2} ( f ) \\ {X}_{Q 2} ( f )\end{matrix} ) = {T}_{4 \times 4} ( f ) ( \begin{matrix}{V}_{XI 1} ( f ) \\ {V}_{XQ 1} ( f ) \\ {V}_{XI 2} ( f ) \\ {V}_{XQ 2} ( f )\end{matrix} ) \qquad ( 11 )$$

T(f) is basically a 4×4 matrix with zeros except for the diagonal elements, but if crosstalk exists between elements inside the drivers 7521 and 7522 or the optical modulator 7400, the elements other than the diagonal elements will also be nonzero. In any case, from Formulas (10a), (10b) and (11), the spectrums U_{X1}(f), U_{X2}(f), U_{X3}(f) and U_{X4}(f) can be expressed as Formula (12).

$$( \begin{matrix}{U}_{X 1} ( f ) \\ {U}_{X 2} ( f ) \\ {U}_{X 3} ( f ) \\ {U}_{X 4} ( f )\end{matrix} ) = {H}_{4 \times 8} ( f ) = ( \begin{matrix}{V}_{XI 1} ( f ) \\ {V}_{XQ 1} ( f ) \\ {V}_{XI 2} ( f ) \\ {V}_{XQ 2} ( f ) \\ \tilde{{V}_{XI 1}} ( f ) \\ \tilde{{V}_{XQ 1}} ( f ) \\ \tilde{{V}_{XI 2}} ( f ) \\ \tilde{{V}_{XQ 2}} ( f )\end{matrix} ) \qquad ( 12 )$$

$$where$$

$${H}_{4 \times 8} ( f ) = {A}_{4 \times 8} ( \begin{matrix}{T}_{4 \times 4} ( f ) & 0 \\ 0 & \tilde{{T}_{4 \times 4}} ( f )\end{matrix} )$$

H_{4×8}(f) includes not only the frequency response of the path from the DACs 7161 and 7162 to the optical modulator 7400, but also the influence of spurious components and delay errors as shown in FIG. 9. To find the matrix for obtaining V from U, that is, the compensation matrix, it is sufficient to find a matrix equivalent to the inverse matrix of H_{4×8}(f). To do this, first, H_{4×8}(f) is decomposed into two 4×4 matrices H_{L}(f) and H_{R}(f) and expressed as H_{4×8}(f)=(H_{L}(f),H_{R}(f)). Then, by expanding Formula (12) by adding a folding signal to the U vector, it can be expressed as Formula (13).

$$( \begin{matrix}{U}_{X 1} ( f ) \\ {U}_{X 2} ( f ) \\ {U}_{X 3} ( f ) \\ {U}_{X 4} ( f ) \\ \tilde{{U}_{X 1}} ( f ) \\ \tilde{{U}_{X 2}} ( f ) \\ \tilde{{U}_{X 3}} ( f ) \\ \tilde{{U}_{X 4}} ( f )\end{matrix} ) = {H}_{8 \times 8} ( f ) ( \begin{matrix}{V}_{XI 1} ( f ) \\ {V}_{XQ 1} ( f ) \\ {V}_{XI 2} ( f ) \\ {V}_{XQ 2} ( f ) \\ \tilde{{V}_{XI 1}} ( f ) \\ \tilde{{V}_{XQ 1}} ( f ) \\ \tilde{{V}_{XI 2}} ( f ) \\ \tilde{{V}_{XQ 2}} ( f )\end{matrix} ) where {H}_{8 \times 8} ( f ) = ( \begin{matrix}{H}_{L} ( f ) & {H}_{R} ( f ) \\ \tilde{{H}_{R}} ( f ) & \tilde{{H}_{L}} ( f )\end{matrix} ) \qquad ( 13 )$$

Therefore, the V vector on the right side of Formula (13) is Formula (14a) and Formula (14b). If G_{8×8}(f) is decomposed into two 4×8 matrices G_{U}(f) and G_{L}(f), and expressed as Formula (15), it becomes Formula (16).

$$( \begin{matrix}{V}_{XI 1} ( f ) \\ {V}_{XQ 1} ( f ) \\ {V}_{XI 2} ( f ) \\ {V}_{XQ 2} ( f ) \\ \tilde{{V}_{XI 1}} ( f ) \\ \tilde{{V}_{XQ 1}} ( f ) \\ \tilde{{V}_{XI 2}} ( f ) \\ \tilde{{V}_{XQ 2}} ( f )\end{matrix} ) = {G}_{8 \times 8} ( f ) ( \begin{matrix}{U}_{X 1} ( f ) \\ {U}_{X 2} ( f ) \\ {U}_{X 3} ( f ) \\ {U}_{X 4} ( f ) \\ \tilde{{U}_{X 1}} ( f ) \\ \tilde{{U}_{X 2}} ( f ) \\ \tilde{{U}_{X 3}} ( f ) \\ \tilde{{U}_{X 4}} ( f )\end{matrix} ) \qquad ( 14 a )$$

$$where$$

$${G}_{8 \times 8} ( f ) = {( \begin{matrix}{H}_{L} ( f ) & {H}_{R} ( f ) \\ \tilde{{H}_{R}} ( f ) & \tilde{{H}_{L}} ( f )\end{matrix} )}^{− 1} \qquad ( 14 b )$$

$${G}_{8 \times 8} ( f ) = ( {{G}_{U} ( f ) \atop {G}_{L} ( f )} ) \qquad ( 15 )$$

$$( \begin{matrix}{V}_{XI 1} ( f ) \\ {V}_{XQ 1} ( f ) \\ {V}_{XI 2} ( f ) \\ {V}_{XQ 2} ( f )\end{matrix} ) = {G}_{U} ( f ) ( \begin{matrix}{U}_{X 1} ( f ) \\ {U}_{X 2} ( f ) \\ {U}_{X 3} ( f ) \\ {U}_{X 4} ( f ) \\ \tilde{{U}_{X 1}} ( f ) \\ \tilde{{U}_{X 2}} ( f ) \\ \tilde{{U}_{X 3}} ( f ) \\ \tilde{{U}_{X 4}} ( f )\end{matrix} ) \qquad ( 16 )$$

This G_{U}(f) is the coefficients of the 8×4 filter unit 7130. Strictly speaking, the derived V_{X11}(f), V_{XQ1}(f), V_{X12}(f), and V_{XQ2}(f) are the spectrums of only positive frequency components, so the function of the 8×4 filter unit 7130 is to perform an inverse Fourier transform on these spectrums and send the real-part signals to the DACs 7161 and 7162.

To actually determine the coefficients of the 8×4 filter unit 7130, first, H_{4×8}(f) may be measured using a known test signal and the like, and then G_{U}(f) may be calculated from Formulas (14b) and (15) based on that and be used as the coefficients of the 8×4 filter unit 7130.

Note that in the explanation so far, it has been assumed that aliasing does not occur in the DAC 7161 and 7162. For example, when the tail of the spectrum of the drive signal extends beyond ±B/2 as shown in FIG. 10, it has been assumed that the tail of the spectrum is sufficiently within the Nyquist band, that is, ±fₛ/2. If the analog response band of the DAC 7161 and 7162 is sufficiently smaller than fₛ/2, aliasing will not occur, but if this is not the case, it is desirable to prevent aliasing using an anti-aliasing filter or the like. Alternatively, if fₛ=B is set, there will be no problem even if aliasing exists. This is because, in this case, the aliasing that appears outside ±B/2=±fₛ/2 is a folded signal that is the main signal inside folded back at ±B/2=±fₛ/2, so in the model expressed as Formula (10) and subsequent Formulas, the aliasing can be completely incorporated as a signal component of the adjacent frequency slot, and the influence of the aliasing can be compensated for by the 8×4 filter unit 7150, which uses G_{U}(f) in Formula (16) as coefficients. Setting fₛ=B has the advantage that clock synchronization is easier to implement since the ratio of fₛ to the optical CSRZ pulse frequency B/2 is a simple integer ratio of 2:1.

As described above, by using the optical transmitter 7000 including the target signal generator 7120, the spectrum splitter 7130, the folding unit 7140, and the 8×4 filter unit 7150 in the digital signal processor 7100, it is possible to compensate for the delay error of the optical delay unit in the optical modulator 7400 as well as the influence of spurious components due to imperfections in the optical CSRZ pulse generator 7300 and to generate any signal in a signal band within the optical carrier frequency ±B, not limited to a single carrier signal with a symbol rate of 2B.

### INDUSTRIAL APPLICABILITY

According to one embodiment of this disclosure, it is possible to provide a CSRZ-OTDM transmitter that can compensate for the influence of delay errors and spurious components in the digital domain on the transmitting side.

### REFERENCE SIGNS LIST

1000, 2000 Optical modulator
1001, 2001 Input optical port
1002, 2002 Output optical port
1100, 2100 Optical CSRZ pulse generator
1111, 2111 Pulse generator
1151, 2151 Clock source
1200, 2200, 3200, 4200 Optical modulator
1221, 2221 First data modulator
1222, 2222 Second data modulator
1231, 2231, 3231, 3261, 3262, 4231, 4261, 4262 Optical branch
1232, 2232 Optical multiplexer
1241, 2241, 3241 Optical delay unit
3221, 4221 First polarization multiplexing IQ modulator
3221-X, 3221-Y, 3222-X, 3222-Y IQ modulator
3270, 3270, 4270, 4270 90-degree polarization rotation unit
3280, 3280, 4280 Polarization coupling unit
3222, 4222 Second polarization multiplexing IQ modulator
3232-X, 4232-X X-polarization side optical multiplexer
3232-Y, 4232-Y Y-polarization side optical multiplexer
4241-X X-polarization side optical delay unit
4241-Y Y-polarization side optical delay unit
4221-X, 4222-X X-polarization side IQ modulator
4221-Y, 4222-Y Y-polarization side IQ modulator
5000, 6000, 7000 Optical transmitter
5100, 6100, 7100 Digital signal processor
5110, 6110, 7110 Encoding and mapping unit
5120, 6120 Sub-signal generator
5161, 5162, 6161, 6162, 7161, 7162 Digital-to-analog converter (DAC) array
5200, 6200, 7200 Transmitting laser
5300, 6300, 7300 Optical CSRZ pulse generator
5400, 6400, 7400 Optical modulator
5511, 5512, 6511, 6512, 7511, 7512 Delay adjustment unit
5521, 5522, 6521, 6522, 7521, 7522 Driver
6131, 6132, 6133 Sample shift unit
6140 2×2 calculation unit
7120 Target signal generator
7130 Spectrum splitter
7140 Folding unit
7150 8×4 filter unit

1. An optical transmitter comprising a digital signal processor, an optical CSRZ pulse generator, and an optical modulator, wherein
the optical CSRZ pulse generator is configured to output an optical CSRZ pulse train with an electric field waveform frequency of B/2,
the optical modulator includes:
an optical branch that branches an input optical CSRZ pulse train into two;
two data modulators that data-modulate each of the two branched CSRZ pulse trains;
an optical coupling unit that couples the output optical signals from the two data modulators; and
an optical delay unit that provides a delay such that the optical CSRZ pulse train passing through one of the two data modulators is delayed by a time τ with respect to the optical CSRZ pulse train passing through the other data modulator, and
the digital signal processor includes:
a sub-signal generator that alternately distributes a symbol sequence of an optical signal to be finally transmitted from the optical modulator for each symbol and outputs two sub-signals u₁(k) and u₂(k):k=0, 1, 2, and so on;
a first sample shift unit that performs a sample shift on u₂(k) equivalent to a delay of 1/(2B) and outputs u₂′(k);
a 2×2 calculation unit that obtains v₁(k) and v₂′(k) for u₁(k) and u₂′(k) by a formula below
$$( \begin{matrix}{v}_{1} ( k ) \\ {v}_{2}^{′} ( k )\end{matrix} ) = ( \begin{matrix}cos \{ π B ( {t}_{0} + Δτ ) \} & sin \{ π B ( {t}_{0} + Δτ ) \} \\ - sin ( π B {t}_{0} ) & cos ( π {Bt}_{0} )\end{matrix} ) ( \begin{matrix}{u}_{1} ( k ) \\ {u}_{2}^{′} ( k )\end{matrix} )$$
using Δτ=τ−1/(2B) and t₀ as parameters; and
a second sample shift unit that performs a sample shift on v₂′(k) according to B to obtain v₂(k).

2. An optical transmitter comprising a digital signal processor, an optical CSRZ pulse generator, and an optical modulator, wherein
the optical CSRZ pulse generator is configured to output an optical CSRZ pulse train with an electric field waveform frequency of B/2,
the optical modulator includes:
an optical branch that branches an input optical CSRZ pulse train into two;
two data modulators that data-modulate each of the two branched CSRZ pulse trains;
an optical coupling unit that couples the output optical signals from the two data modulators; and
an optical delay unit that provides a delay such that the optical CSRZ pulse train passing through one of the two data modulators is delayed by a time τ with respect to the optical CSRZ pulse train passing through the other data modulator, and
the digital signal processor includes, for each of X and Y polarization components:
a target signal generator that virtually generates a target signal having spectral components within approximately a frequency of B;
a spectrum splitter that virtually splits the spectrum of the target signal into four adjacent parts spaced approximately by B/2, and generates four digital split signals which correspond to signals virtually frequency-shifted to a baseband;
a folding unit that obtains four folded digital split signals by inverting each of the four digital split signals on a frequency axis around a frequency of B/4 and taking complex conjugate; and
an 8×4 filter unit that receives an input of the four digital split signals and the four folded digital split signals, and outputs four drive signals which correspond to the I and Q components
in each of the X and Y polarization channels of each of the two data modulators.
